(19) United States
(12) Patent Application Publication
(10) Pub. No.: US 2022/0240716 A1
(43) Pub. Date: Aug. 4, 2022

(54) PLANETARY OVEN SYSTEM

(71) Applicants: Estevam Luiz Del Nero Costa Marques, Orlando, FL (US); Daniel Estevam Galdino Costa Marques, Orlando, FL (US)

(72) Inventors: Estevam Luiz Del Nero Costa Marques, Orlando, FL (US); Daniel Estevam Galdino Costa Marques, Orlando, FL (US)

(21) Appl. No.: 17/585,862

(22) Filed: Jan. 27, 2022

Related U.S. Application Data
(60) Provisional application No. 63/143,469, filed on Jan. 29, 2021.
(60) Provisional application No. 63/240,679, filed on Sep. 3, 2021.
(60) Provisional application No. 63/255,585, filed on Oct. 14, 2021.

(51) Int. Cl. A47J 37/04; A47J 37/06

(52) U.S. Cl. CPC A47J 37/046; A47J 37/0664; A47J 37/041

(57) ABSTRACT

A planetary oven system includes a main body having a heating chamber for receiving a natural fuel source or a controlled heat source. A planetary cooking assembly is positioned along the main body and includes a large rotating primary cooking disc, and a plurality of secondary discs which are removably connected to the primary cooking disc. Each of the secondary cooking discs independently rotate relative to the primary disc, and are selectively raised and lowered relative to the primary disc. A heat shield is positioned along the main body between the heating chamber and the planetary cooking assembly. The heat shield includes a retractable body member. In the retracted position, the heat shield is positioned within the main body, and in the extended position, the heat shield extends upward to block a portion of the heat radiating from the heating chamber from reaching the planetary cooking assembly.

### CROSS-REFERENCE TO RELATED APPLICATIONS

This application claims the benefit of U.S. Application Ser. No. 63/143,469, filed on Jan. 29, 2021, U.S. Application Ser. No. 63/240,679, filed on Sep. 3, 2021, and U.S. Application Ser. No. 63/255,585, filed on Oct. 14, 2021, the contents of each of which are incorporated herein by reference.

### TECHNICAL FIELD

The present invention relates generally to ovens, and more particularly to a planetary oven system having a plurality of rotating discs for applying heat evenly to items being cooked.

### BACKGROUND

The statements in this section merely provide background information related to the present disclosure and may not constitute prior art.

Ovens have been used for centuries to cook a wide variety of food items. As such, modern manufacturers produce several varieties of ovens for use in residential and commercial kitchens.

Aside from general purpose ovens such as single or double chamber ovens which may be freestanding or built into a kitchen cabinet, there are many other types of specialty ovens for use in certain industries. For example, brick ovens are frequently used by commercial eateries to prepare pizza. Brick ovens may be made of refractory brick and powered by gas, wood or electricity. Typically, the interior of the gas or wood oven may include an area in which the fire is confined and an adjacent area in which the pizza is placed to be cooked. Heat radiates from the fire to the pizza to cook the pizza by convection typically over a period of a few minutes. When cooking is complete, the pizza is removed from the oven and served or delivered to the customer.

In restaurants, brick ovens may be designed for high-output production. Placing pizza or other food into, moving food internally and removing the food from these types of ovens may require the skills of experienced cooks or chefs, who may use shovel-like tools having an elongated handle. A pan may terminate the handle to enable the cook to lift the pizza by grasping and manipulating the handle. When a pizza is baked in a wood-fired oven, it needs to be rotated inside the oven to allow the pizza to cook evenly across its surface. As such, the cook must constantly utilize the spatula to reposition the pizza throughout the cooking process.

One of the limitations of brick ovens is that of poor or non-uniform heat distribution in the oven. The areas of the oven which are closest to the fire are the hottest, whereas areas farther away from the fire are cooler. This disparity in temperatures may result in pizzas and other food items which are unevenly cooked and/or burned in some spots, especially along the edges. Therefore, close supervision and vigilance of the cooking process by the kitchen staff is essential to ensure an ideal baking environment.

Accordingly, it would be beneficial to provide a planetary oven system having a plurality of rotating discs for applying heat evenly to all sides of the items being cooked.

### SUMMARY OF THE INVENTION

The present invention is directed to a planetary oven system. One embodiment of the present invention can include a main body having a top surface, a bottom surface, a plurality of side surfaces and an interior space, and a heating chamber can be disposed along the top surface of the main body and can function to receive one or both of a natural fuel source or a controlled heat source.

One embodiment of the present invention can also include a planetary cooking assembly that is positioned along the main body. The planetary cooking assembly can include a large primary cooking disc that is selectively rotated by a system controller. The large primary disc can include a plurality of apertures for receiving a plurality of secondary discs which can move with the rotation of the primary disc.

In one embodiment, each of the secondary discs can also be in communication with the system controller and can independently rotate relative to the primary disc. Each of the secondary discs can also include functionality for being selectively elevated relative to the primary disc.

In one embodiment, a heat shield device can be positioned along the main body at a location between the heating chamber and the planetary cooking assembly. The heat shield can include a body member that transitions between a retracted position and an extended position. In the retracted position, the body member of the heat shield can be positioned within the main body, and in the extended position, the body member of the heat shield can extend upward from the top surface and can function to block a portion of the heat radiating from the heating chamber from reaching the planetary cooking assembly.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of one embodiment of the planetary oven system that is useful for understanding the inventive concepts disclosed herein.

FIG. 2 is a perspective view of the planetary oven system, in accordance with one embodiment of the invention.

FIG. 3 is front view of the planetary oven system in operation, in accordance with one embodiment of the invention.

FIG. 4 is an exploded parts view of the planetary cooking assembly of the planetary oven system, in accordance with one embodiment of the invention.

FIG. 5 is perspective view of the planetary oven system in operation, in accordance with one embodiment of the invention.

FIG. 6 a simplified block diagram of the system controller of the planetary oven system, in accordance with one embodiment of the invention.

FIG. 7 is another perspective view of the planetary oven system, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

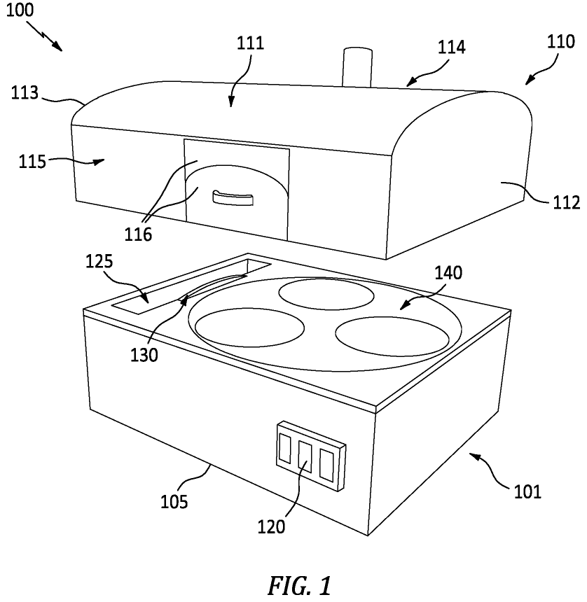

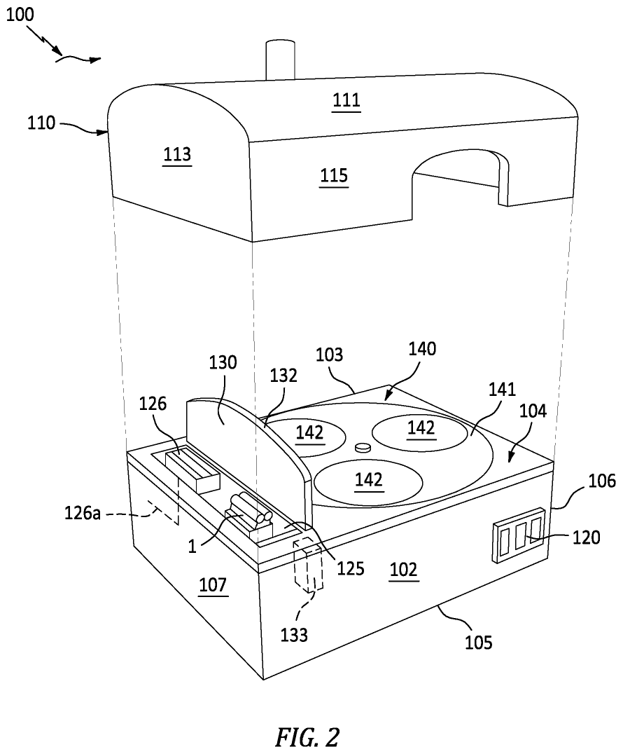

FIGS. 1-7 illustrate one embodiment of a planetary oven system 100 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in the drawings, one embodiment of the system 100 can include, essentially, a main body 101, an oven cover 110, at least one heating chamber 125, a retractable heat shield 130, and a planetary cooking assembly 140.

The main body 101 of the system 100 can function to house the device components in the manner described herein. In one embodiment, the main body can include a generally rectangular-shaped member having a front surface 102, a back surface 103, a top surface 104, a bottom surface 105, and a pair of side surfaces 106 and 107 that form a generally hollow interior space. Each of the surfaces of the main body may be joined together with an adjacent surface in either a permanent or removable manner, so as to allow various panels to be removed in order to access the interior space.

In the preferred embodiment, the main body will be constructed from a metal such as steel, for example, however any number of other materials such as different types of metals, metal alloys, or composite materials, for example, that are suitable for prolonged exposure to high heat without deforming are also contemplated. Although described above with regard to a rectangular shape, this is for illustrative purposes only, as the main body may be constructed to include any number of different shapes and sizes.

The cover 110 can be permanently or removably connected to the top of the housing 101 and can function in the expected manner to contain the heat produced by the oven during operation. In one embodiment, the cover can include a generally curvilinear top wall 111, side walls 112 and 113, a back wall 114, and a front wall 115. Any number of doors 116, each having any number of different shapes and sizes can be positioned along the cover, in order to allow a user to selectively access the oven components.

In the preferred embodiment, the cover will be constructed from the same material as the main body 101, however any number of other materials suitable for exposure to the high heat generated by the oven during operation are also contemplated.

A user control panel 120 can be secured along the main body 101 or the cover 110 and can include any number of integrated buttons, switches, display screens and/or touch screen devices, which can send and/or receive information with a user. The user control panel can be communicatively linked to the below described system controller 150 in order to control the operation of the oven as described below.

The heating chamber 125 can function to house one or more types of heat sources for supplying heat to the oven during operation. In one embodiment, the heating chamber 125 can include one or more elongated cavities that extend downward from the top surface 104 forming a recessed area into which one or more heat source components can be positioned.

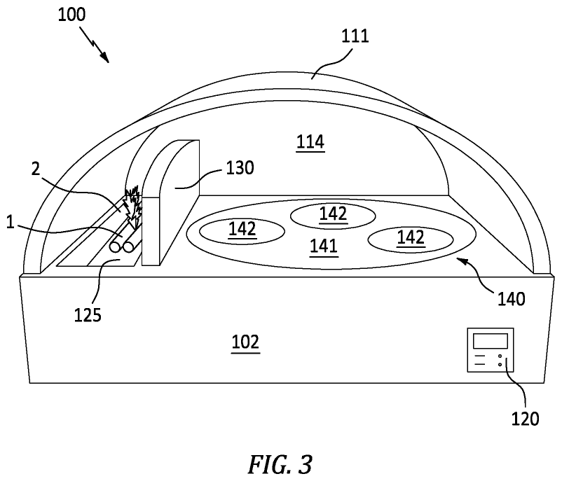

For example, the oven 100 can utilize a natural fuel source 1 such as coal or wood, for example, which can be deposited directly into the heating chamber 125 and burned 2 (See FIG. 3). Additionally, the heating chamber can receive or comprise a controlled heat source 126 such as electric heating elements and/or propane burners, among others, for example, which may be positioned into the chamber cavity and communicatively linked with the below described system controller 150 via a cable 126a or wireless communication device, for example.

Although described above with regard to a particular shape, size, or material, this is for illustrative purposes only, as the heating chamber or chambers can each include any number of different shapes and sizes and can be located anywhere along or within the main body.

The retractable heat shield 130 can function to allow a user to regulate and control the cooking temperature of the oven when utilizing a natural fuel source 1 such as wood or coal in the heating chamber. As such, in the preferred embodiment, the heat shield 130 can be positioned between the heating chamber 125 and the planetary cooking assembly 140.

In one embodiment, the heat shield 130 can include an elongated, generally planar main body that is constructed from a single piece of rigid metal such as steel, for example. As shown by arrow a, the heat shield 130 can extend from and retract within the top surface 104 of the main body in order to selectively block a portion of the heat radiated from the heating chamber 125 toward the Planetary cooking assembly 140.

In one embodiment, the heat shield can include a curved top surface 132 having a shape and size that is complementary to the cross-sectional shape and size of the inside portion of the top wall of the cover 111. Such a feature permitting the entire top surface 132 to be positioned against the curved inner surface of the cover when the shield is in the fully extended position.

In one embodiment, the heat shield can be raised and lowered via an electric motor 133 which can be located within the main body 101. As described herein, the motor 133 can include, comprise, or consist of any number of different devices capable of imparting a lifting force onto the shield body in order to raise and lower the same. To this end, the electric motor can include a linear actuator motor that is directly coupled to the side or bottom of the shield body, and/or a rotational motor that is connected to the shield body via any number of panel teeth, gear lobes, or pulley mechanisms, for example. In either instance, the electric motor can be communicatively linked to the below described system controller 150, in order to receive operating instructions therefrom.

Although described above with regard to a particular shape, size, or construction material, this is for illustrative purposes only. To this end, the heat shield can include any number of different shapes and sizes and may be constructed from any number of different materials suitable for prolonged exposure to the high heat and cooking temperatures produced by the oven during operation. Additionally, other embodiments are contemplated wherein the shield body includes a malleable construction which may include a plurality of individual panels that are mechanically linked together so as to permit the shield body to bend, flex and/or roll when transitioning between the extended and retracted positions. Likewise, other embodiments are contemplated wherein the shield includes a handle or pulley system that permits a user to manually transition the shield between the extended and retracted positions.

The Planetary cooking assembly 140 can function to receive any type of food items to be heated by the oven and can function to rotate and/or elevate the items in accordance with commands from the system controller. To this end, the assembly can include a primary disc which rotates within the oven, and a plurality of secondary discs which independently rotate as well. This interrelation of discs mimics the movement of a solar system, hence the planetary nomenclature.

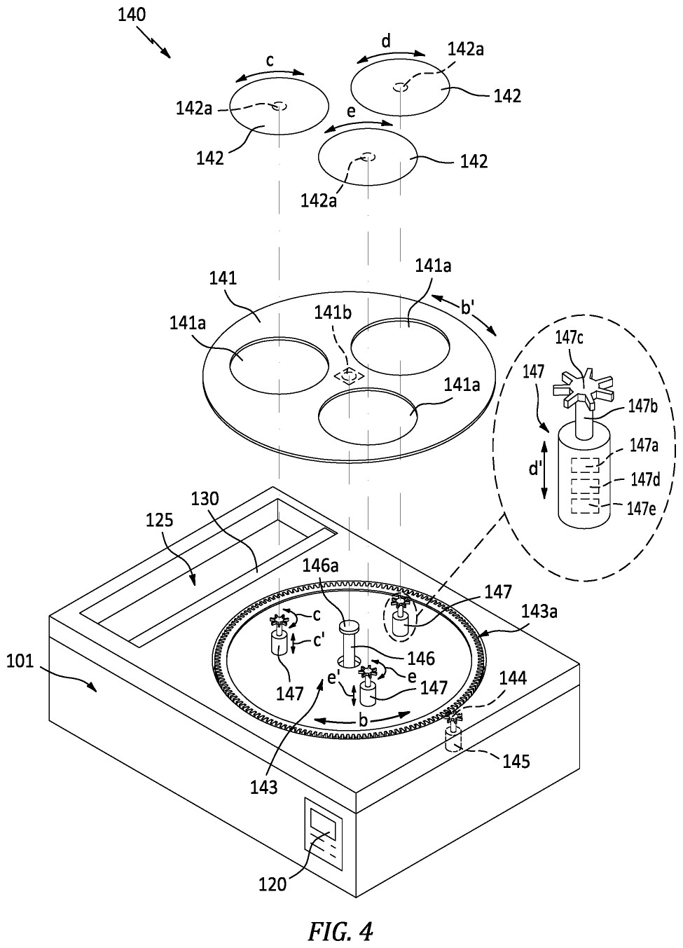

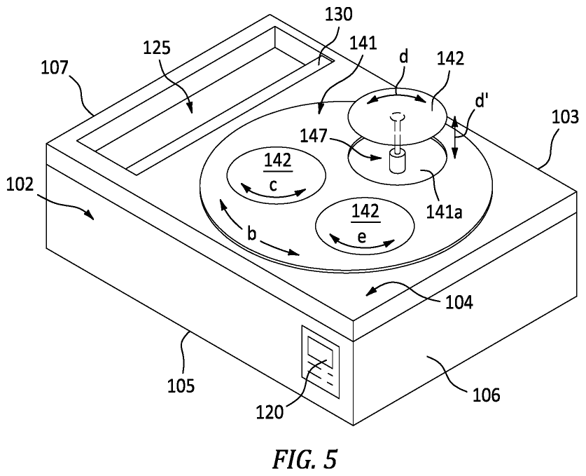

As shown best at FIGS. 4 and 5, the planetary cooking assembly may be provided along the main body so as to be adjacent to the heat shield 130. In one embodiment, the assembly 140 can include a primary disc 141 having a plurality of secondary disc members 142 that are removably positioned within complementary shaped openings 141a along the primary disc 141.

As described herein, each of the secondary disc members can be constructed from any number of different materials suitable for cooking human food, such as steel or cast iron, for example. In this regard, during operation of the oven, the secondary discs can be chosen based on the type of food that is being cooked, and different discs having different materials can be used at the same time. Moreover, each of the openings and disc members can include any number of different shapes and sizes.

In one embodiment, a rotating disc support plate 143 can be recessed within the main body. In the illustrated embodiment, the support plate 143 can include a generally circular-shaped plate having a plurality of gear teeth 143a along the outer edge. The teeth of the ring gear can be connected to an angular drive gear 144 that is connected to a primary turntable motor 145 which selectively rotates the support plate 143 as shown by arrow b. The motor 145 can be connected to the system controller to receive operating instructions.

In one embodiment, a vertical spacer bar 146 can be mounted centrally along the support plate 143. The vertical spacer bar can include a metallic shaft having a mounting plate 146a that is positionable within a complementary shaped cavity 141b along the bottom of the primary disc 141. Such a feature permits the primary disc to be removably connected to the spacer bar, and to rotate (arrow b′) in accordance with the rotation of the support plate 143.

In one embodiment, a plurality of motor assemblies 147 can be secured along the support plate 143. Each of the motor assemblies can include an electric motor 147a that is connected to an elongated shaft 147b having a mounting plate 147c along a distal end. In one embodiment, the mounting plate 147c can include a shape and size that is complementary to the shape and size of a receptacle 142a located along the bottom surface of each of the secondary discs 142. In this regard, each of the motor units 147 can impart a horizontal rotational force (see arrows c, d, and e) onto the secondary disc 142 to which the respective motor assembly is connected. Such a feature permitting each of the secondary discs 142 to independently rotate as they are being moved along in a circular pattern by the primary disc 141.

In one embodiment, the length of the elongated shaft 147b of one or more of the gear assemblies 147 can be adjustable. In this regard, the motor assembly can include a linear actuator 147d, or other such component which can selectively extend and retract the elongated shaft. As shown by arrows c′, d′ and e′, such a feature allows the system to selectively and individually raise and lower the secondary disc 142 to which the motor assembly is connected during operation of the oven relative to the surface of the primary disc 141.

In one embodiment, the angle of the elongated shaft 147b of one or more of the gear assemblies 147 can be adjustable. In this regard, the motor assembly can include a ball and joint arrangement which can selectively tilt the elongated shaft.

In this regard, it is noted that the motor assembly can impart a simultaneous rotational force (e.g., arrows c, d and e), along with a vertical and angular force (e.g., arrows c′, d′ and e′) onto a single disc 142 at a time, so as to permit the disc to rotate horizontally, lift vertically, and to tilt angularly relative to the primary disc. One suitable example of a motor assembly which can be used to provide the rotation, lift and angular movement includes the ball and socket tilt and 360-degree rotation platform model M-RN-86 that is commercially available from Newport products, for example, however, any number of other components are also contemplated.

In the preferred embodiment, a weight sensor 147e can be positioned along the motor assembly 147 and can function to detect the weight of the secondary disc 142 and any food items resting thereon. As will be described below, the weight sensor can function in conjunction with other system components to change the operation of the oven based on the weight of items being cooked within any of the discs 142.

In either instance, each of the motor 145 and the motor assemblies 147, including the rotational motors 147a, angular and linear actuators 147d and weight sensors 147e can each be connected to the system controller 150 via a communication cable or wireless adaptor, in order to send and receive information therewith.

Although described above as an integrated component, this is for illustrative purposes only, to this end, each of the motor assemblies can include any number of discrete components that are arranged and connected so as to function in the manner described above. Although described above with regard to a particular type, number, or arrangement of components for permitting the primary disc and secondary discs to move during operation of the oven this is for illustrative purposes only. To this end, those of skill in the art will recognize that many other arrangements of components can be provided to permit movement of the primary and secondary cooking discs in the manner described herein, along with any number of other manners, without undue experimentation. As such, the inventive concepts are not to be construed as limiting to the type, number, or arrangement of components described above.

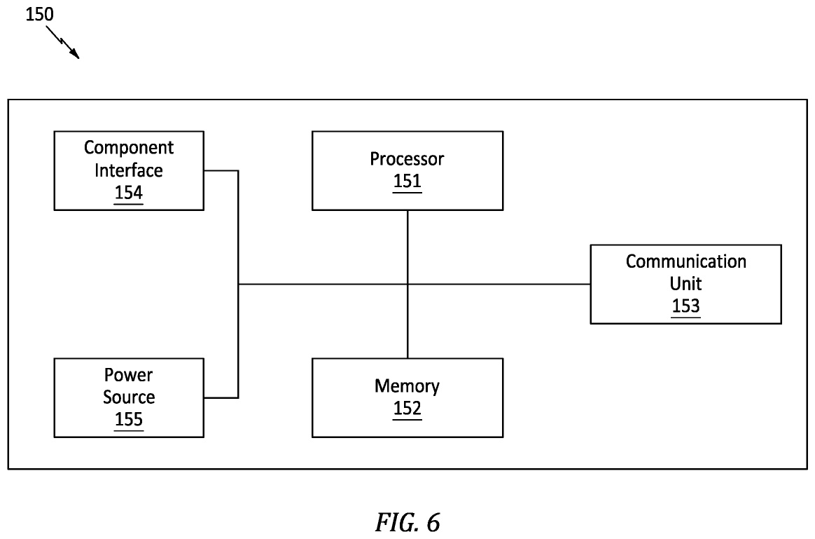

FIG. 6 illustrates one embodiment of the system controller 150 which can be positioned within the oven 100 and communicatively linked to the various oven components. As shown, the controller can include a processor 151 that is conventionally connected to an internal memory 152, a communication unit 153, a component interface unit 154, and/or a power source 155.

Although illustrated as separate elements, those of skill in the art will recognize that one or more controller components may comprise or include one or more printed circuit boards (PCB) containing any number of integrated circuit or circuits for completing the activities described herein. Of course, any number of other analog and/or digital components capable of performing the below described functionality can be provided in place of, or in conjunction with the below described controller elements.

The processor 151 can be a conventional central processing unit (CPU) or any other type of device, or multiple devices, capable of manipulating or processing information such as program code stored in the memory 152 and for causing the oven to function in the manner described herein.

Memory 152 can act to store operating instructions in the form of program code for the processor 151 to execute. Although illustrated in FIG. 6 as a single component, memory 152 can include one or more physical memory devices such as, for example, local memory and/or one or more bulk storage devices. To this end, the controller memory can also function to receive and store customized settings such as set rotation speeds of the primary and secondary discs, along with different heights, angles, and rotational directions of the same, among others, for example.

The communication unit 153 can include any number of components capable of sending and/or receiving electronic signals with an externally located device, either directly or over a network. In one embodiment, the communication unit can include a network adapter for connecting with a user's local Wi-Fi network, for example. Such a feature allowing the oven to communicate directly with a user device such as a smartphone, personal computer, or tablet computer running a mobile application.

Such functionality allowing the oven to operate as a “smart appliance” and permitting the user to remotely operate the oven to change settings such as the orientation of the heat shield 130, the temperature of the controlled heat source 126, and the operation of the primary and secondary cooking discs, for example.

Although described above with regard to using a wired or wireless network adapter, this is for illustrative purposes only. To this end, the communication unit 153 can include any number of other known transmission protocols such as a cellular transceiver, Wi-Fi transceiver or Bluetooth transceiver, among others, for example.

The component interface unit 154 can function to provide a communicative link between the processor 151 and various other device components such as the oven thermocouple/temperature sensor, the control panel 120, the controlled heat source 126, the heat shield motor 133, the primary disc motor 145, and the secondary motor assemblies 147 including the disc motors 147a, the secondary disc linear motors 147d, and the secondary disc weight sensors 147e, for example. In this regard, the component interface unit can include any number of different components such as one or more PIC microcontrollers, internal bus, USB connections and other such hardware capable of providing a direct link between the various components. Of course, any other means for providing one or two-way communication between various system components can also be utilized herein.

In one embodiment, the power source 155 can include an A/C electrical power transformer and cord capable of allowing the electrical components of the oven device to be powered from a residential or commercial electrical outlet. Of course, other embodiments are also contemplated wherein the power source can include one or more batteries, so as to allow the various motors and system components to operate in the event of a building power failure.

In operation, the primary cooking disc 141 can rotate in a clockwise or counterclockwise manner at varying speeds to allow items being cooked directly on the primary cooking disc to receive radiant heat from the heating chamber. Additionally, each of the secondary cooking discs 142 can independently rotate in a clockwise or counterclockwise manner at varying speeds to permit all sides of the items being cooked on the discs to receive heat evenly from the heating chamber as the secondary discs themselves are rotated about the heating chamber 125 by the primary disc 141. Additionally, because hot air rises, the ability of the secondary cooking discs 142 to independently elevate the food items to different heights relative to the primary cooking disc allows for different items within the oven to cook at different temperatures at the same time.

In addition to the above, the oven 100 permits manual or automatic regulation of the amount of radiant heat traveling from the heating chamber 125 to the Planetary cooking assembly 140 by selectively raising and lowering the heat shield 130. To this end, the oven can include functionality for monitoring the temperature of the oven interior, the primary cooking disc and/or each of the secondary cooking discs and can raise or lower the heat shield to decrease or increase the temperature, respectively. Such a feature being particularly advantageous when cooking with natural fuel sources such as wood or coal, for example, whose heat output cannot be otherwise artificially adjusted.

In addition to the above, one embodiment of the oven can include functionality for selectively operating the heat shield based upon the weight of an item being cooked on one or more of the secondary cooking discs 142. For example, when the weight sensor 147e of a disc 142 detects a dense item having a weight at or above a user defined setting (e.g., 10 pounds), the control unit can automatically lower the heat shield 130 as the primary disc 141 rotates the particular secondary disc 142 toward the heating chamber 125 in order to raise the amount of direct heat. Then, as the particular secondary cooking disc moves away from the heating chamber, the control unit can raise the heat shield 130 to lower the temperature/direct amount of heat for the subsequent disc that is approaching, and vice versa.

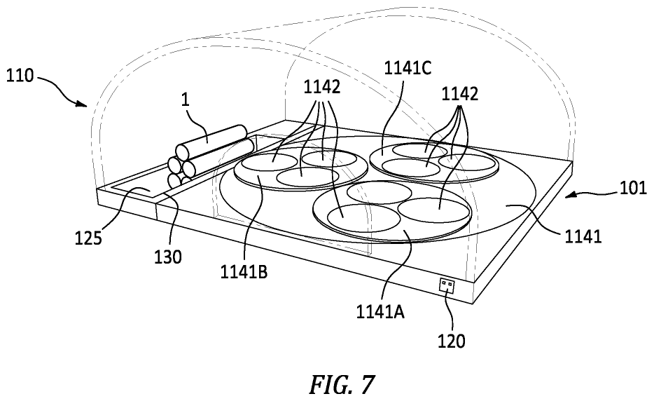

Although described above with regard to a single cooking disc assembly and heating chamber arrangement, this is for illustrative purposes only. To this end, FIG. 7 illustrates one embodiment of the planetary oven system 100 wherein the planetary cooking assembly includes an enlarged primary cooking disc 1141, that houses a plurality of smaller primary cooking discs 1141a, 1141b and 1141c, each having a plurality of secondary cooking disc members 1142, respectively.

As described herein, the enlarged primary cooking disc element 1141 can be a larger version of the primary cooking disc 141 described above. The plurality of smaller primary cooking discs 1141a, 1141b and 1141c can be positioned onto the enlarged disc 1141 and can each be identical to element 141 described above, and each of the elements 1142 can be identical to element 142 described above, therefore duplicate descriptions of the subcomponents and operations for each of these components need not be repeated.

However, the illustrated system provides a single enlarged primary disc (e.g., 1141) which rotates a plurality of primary discs (e.g., 1141a, 1141b, and 1141c), each having a plurality of secondary discs 1142 that are independently moveable. As such, the inventive oven can greatly increase the capacity of items which may be cooked at a single time, so as to be beneficial for commercial endeavors such as restaurants, and/or large-scale food production facilities.

In another embodiment (not illustrated) the oven can also include a plurality of cooking disc assemblies, along with multiple heat shields and heating chambers to permit a single oven to use one or both of a natural fuel source and/or a controlled heat source at the same time. Such a feature being particularly advantageous for allowing the natural fuel source to impart the smoky wood or coal flavor onto the items being cooked, while the controlled heat source regulates the overall temperature of the oven alone, or in combination with the heat shields.

As described herein, one or more elements of the planetary oven system 100 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An oven system, comprising:
a main body having a top surface, a bottom surface, a plurality of side surfaces and an interior space; and
a planetary cooking assembly that is positioned along the main body, said planetary cooking assembly including a primary cooking disc and a plurality of secondary cooking discs,
wherein the primary cooking disc is configured to rotate within the main body and each of the plurality of secondary cooking discs are configured to rotate within the primary cooking disc.

2. The system of claim 1, further comprising:
a system controller that is in communication with the planetary cooking assembly, said system controller functioning to instruct the planetary cooking assembly to selectively rotate each of the primary cooking disc and the plurality of secondary cooking discs.

3. The system of claim 1, wherein at least one of the secondary cooking discs are removably positioned onto the primary cooking disc.

4. The system of claim 3, wherein the primary cooking disc includes a plurality of openings, and each of the secondary cooking discs are removably positioned within one of the plurality of openings.

5. The system of claim 1, further comprising:
a motor that is in communication with at least one of the secondary cooking discs, said motor including functionality for selectively raising and lowering the at least one secondary cooking disc relative to the primary cooking disc.

6. The system of claim 1, further comprising:
a heating chamber that is disposed along the main body, said heating chamber including an elongated cavity that is disposed along the top surface of the main body.

7. The system of claim 6, wherein the heating chamber is positioned adjacent to the planetary cooking assembly.

8. The system of claim 7, wherein the heating chamber is configured to receive a natural fuel source to be burned within the heating chamber.

9. The system of claim 8, further comprising:
a controlled heat source that is positioned within the heating chamber.

10. The system of claim 1, further comprising:
a domed cover that is connected to the main body.

11. An oven system, comprising:
a main body having a top surface, a bottom surface, a plurality of side surfaces and an interior space;
a heating chamber that is disposed along the main body;
a heat shield that is positioned along the main body;
a planetary cooking assembly that is positioned along the main body, said planetary cooking assembly including a primary cooking disc and a plurality of secondary cooking discs; and
a system controller that is in communication with the heat shield and the planetary cooking assembly, said system controller functioning to control an operation of the heat shield, and to instruct the planetary cooking assembly to selectively rotate each of the primary cooking disc and the plurality of secondary cooking discs.

12. The system of claim 11, wherein the heat shield is positioned between the heating chamber and the planetary cooking assembly.

13. The system of claim 11, wherein the heat shield is configured to transition between a retracted position and an extended position.

14. The system of claim 13, wherein in the retracted position, the heat shield is located within the interior space of the main body.

15. The system of claim 14, wherein in the extended position the heat shield extends upward from the top surface of the main body.

16. The system of claim 13, further comprising:
a motor that is in physical communication with the heat shield and is in electrical communication with the system controller,
said motor functioning to automatically transition the heat shield between the extended position and the retracted position upon receiving a command from the system controller.

17. The system of claim 16, further comprising a control panel that is positioned along the main body, said control panel functioning to receive user commands to selectively operate the planetary cooking assembly and the heat shield.

18. The system of claim 11, wherein the heating chamber includes an elongated cavity that is disposed along the top surface of the main body.

19. The system of claim 18, wherein the heating chamber is configured to receive a natural fuel source to be burned within the heating chamber.

20. The system of claim 19, wherein the heat shield is positioned between the heating chamber and the planetary cooking assembly, and is configured to selectively block a portion of a heat that is generated from the natural fuel source from being radiated toward the planetary cooking assembly.
